(19) United States
(12) Patent Application Publication
(10) Pub. No.: US 2006/0254274 A1
(43) Pub. Date: Nov. 16, 2006

(54) Hydraulic turbine assisted turbocharger system

(76) Inventor: Davorin Kapich, Carlsbad, CA (US)

Correspondence Address: John R. Ross, P.O. Box 2138, Del Mar, CA, 92014, US

(21) Appl. No.: 11/430,806

(22) Filed: May 8, 2006

Related U.S. Application Data
(60) Provisional application No. 60/680,641, filed on May 14, 2005.

(51) Int. Cl. F02B 33/00; F02B 33/44

(52) U.S. Cl. 60/612; 123/559.1; 123/565

(57) ABSTRACT

A very high efficiency, high speed radial inflow hydraulic turbine driven axial flow supercharger compressor for discharging compressed air directly into the inlet of a standard turbocharger supplying a very high pressure ratio compressed air to an internal combustion engine. A hydraulic fluid pump driven by the engine provides high pressure hydraulic fluid to drive the hydraulic turbine. All embodiments include features to prevent foaming of hydraulic fluid at the intake of the hydraulic fluid pump. A preferred embodiment includes a single-stage supercharger configuration combined with standard turbocharger that can produce a combined total pressure ratio up to 4.75. The supercharger in a two-stage configuration, combined with a standard turbocharger can produce total pressure ratio up to 5.5. Choice of using a single-stage or a two-stage supercharger compressor would depend on boost requirement of the particular engine. In the preferred embodiments pressurized hydraulic fluid driving the hydraulic turbine is provided by an engine-driven pump or by an engine-driven pump combined with a high-pressure hydraulic fluid accumulator charged by the engine driven pump. During typical “stop and go” driving situations, the accumulator is charged by the engine-driven pump using energy of decelerating vehicle whenever possible, thus improving the fuel economy of the vehicle. In a preferred embodiment, when the hydraulic turbine is not needed because sufficient air is provided by turbocharger alone, a hydraulic bypass valve is opened by a controller unloading the hydraulic pump in sequence with opening the clutch and disconnecting the pump from the engine drive. When the hydraulic turbine is needed to drive the compressor, the controller connect the clutch first and then sequentially starts closing the bypass valve to produce required amount of boost to the engine. Each of several preferred embodiments utilize a plastic-metal turbine wheel (similar to the turbine wheel described in Applicant's '286 patent in which the plastic portion of the wheel other than the blades is solidly anchored within a metal containing wheel. The superchargers provided by the present invention produce immediate response to engine demand for increased combustion air and re-circulated combustion gases and will dramatically reduce emission of particulate matter and nitrous oxides during steady state driving and especially during low speed acceleration of bus and truck diesel engines.

This application claims the benefit of Provisional Application Ser. No. 60/680,641 filed May 14, 2005. The present invention relates to turbochargers and to assisted turbochargers.

### BACKGROUND OF THE INVENTION

In order to provide more power to the on-highway and off-highway vehicles, power density of heavy duty turbocharged diesel engines has been increasing with time. This has required ever higher levels of turbo-charging that in many cases have exceeded capability of a single turbocharger. Many engine applications have been forced to utilize two stage turbo-charging. New emission standards require drastic reduction in nitrous oxides and particulate matter. To help meet these standards a portion of the exhaust flow is often recirculated back through the engine. High rates of combustion air are required to keep exhaust particulate matter low. Exhaust gas recirculation (EGR) combined with increases in the combustion air have required compressor power levels exceeding the power levels that the exhaust turbine can produce efficiently. High back pressuring of the engine by the turbocharger turbine to increase exhaust turbine power has resulted drastic loss of engine volumetric efficiency, thus in effect reducing the amount of combustion air especially in the lower engine speed range when power is most needed for vehicle acceleration and low emissions. Several studies have been conducted and published on this subject, such as an articles written by Dr. Joachim Weiss of MAN Nutzfahrzeuge, Nuemberg, Germany, published in Diesel Progress, North American Edition, August 2003. The writer concludes that “High EGR rates require correspondingly high boost pressures because the exhaust gas has to supplement the indispensable amount of combustion air and not to substitute it. In view of EGR rates above 20 percent and the demanded high BMEP, the compressor pressure ratio will have to reach values higher than 4.0.” (“BMEP” is “Brake Mean Effective Pressure” based on power, rpm and engine displacement.) Turbocharger systems performance is judged by (1) gas flow and (2) pressure ratio. The pressure ratio is ratio of: (1) the pressure of the gas [mostly air] pumped into the engine to (2) the then atmospheric pressure. SAE Paper No. 2005-01-1546, written by Steve Arnold and others from Honeywell Turbo Technologies, describes development of a two stage, ultra-high high pressure ratio turbocharger. This paper describes development of a single turbocharger with two centrifugal compressor impellers mounted on the same shaft and driven by a single exhaust turbine. U.S. Pat. No. 6,062,028, Low Speed, High Pressure Ratio Turbocharger by Steve Arnold and Gary Vrbas describes a turbocharger with the same concept of two centrifugal “back to back” compressor wheels mounted on the same shaft with the exhaust driven turbine. With this concept, high rotating inertia and lack of required turbine power can be a problem in achieving turbocharger overall performance including transient acceleration response. This results in slow vehicle acceleration. Also, achieving new emission limits could be a problem with this concept.

Applicant was granted a patent (U.S. Pat. No. 5,924,286, issued on Jul. 20, 1999) describing a hydraulic supercharger system using very high speed, high efficiency radial inflow hydraulic turbine. The '286 patent is incorporated herein by reference. FIGS. 3 and 4 of that patent disclose a plastic-metal hydraulic turbine wheel construction in which plastic portion of the wheel other than blades is solidly anchored within metal containing wheel. High pressure hydraulic fluid is supplied into a turbine inlet cavity and flows through a series of nozzle holes optimally positioned in a turbine nozzle ring to drive the plastic-metal turbine wheel. Fluid discharging from turbine wheel flows into turbine discharge cavity. FIGS. 10 and 11 of that patent show the hydraulic turbine driven blower used in combination with a hydraulic system which utilizes a bypass valve in combination with a clutch to couple and decouple the hydraulic pump as needed to produce high pressure fluid to drive the turbine that in turn drives a blower to provide (in combination with a standard turbocharger) the required amount of combustion air to the internal combustion engine. FIG. 12 of that patent discloses a hydraulic driven blower working in combination with a conventional turbocharger to supercharge an internal combustion engine. A hydraulic bypass valve was utilized to control the hydraulic turbine supply pressure and to eliminate pump load during coupling and de-coupling sequence in order to minimize clutch wear. FIGS. 16, 17, 18 and 19 of that patent show configuration details of a high-efficiency hydraulic nozzles and turbine blades design used to achieve turbine hydraulic efficiency in excess of 80 percent. The FIG. 12 drawing of the '286 patent is reproduced in this application as FIG. 6. An important problem with the FIG. 12 design is that in some situations the discharge pressure at the discharge of turbocharger 66 will drop substantially causing a reduction in the pressure in expansion tank 88 to such an extent as t permit foaming at the inlet of pump 81. This greatly degrades pump performance and lifetime.

Applicant is very familiar with turbocharger thermodynamic processes and has developed computer programs able to predict performance of various engine boost systems and has published five SAE Papers on this subject and received approximately 20 United States patents in this area. Applicant was recently awarded the 2005 Technology Award at 2005 SAE World Congress in Detroit for the “Low cost, mass producible, very high speed, high efficiency hydraulic turbine driven superchargers.”

There is a great need for additional supercharging of present turbocharged diesel engines. Thermodynamic cycle analysis and engine tests show that even with a modest 4 to 5 psi supercharging applied in series to the inlet of the existing turbocharger compressor, the turbocharger pressure ratio and engine power increase exponentially due to a large increase in turbocharger turbine power. What is needed is better supercharging system.

### SUMMARY OF THE INVENTION

The present invention provides a very high efficiency, high speed radial inflow hydraulic turbine driven axial flow supercharger compressor for discharging compressed air directly into the inlet of a standard turbocharger supplying a very high pressure ratio compressed air to an internal combustion engine. A hydraulic fluid pump driven by the engine provides high pressure hydraulic fluid to drive the hydraulic turbine. All embodiments include features to prevent foaming of hydraulic fluid at the intake of the hydraulic fluid pump. A preferred embodiment includes a single-stage supercharger configuration combined with standard turbocharger that can produce a combined total pressure ratio up to 4.75. The supercharger in a two-stage configuration, combined with a standard turbocharger can produce total pressure ratio up to 5.5. Choice of using a single-stage or a two-stage supercharger compressor would depend on boost requirement of the particular engine. In the preferred embodiments pressurized hydraulic fluid driving the hydraulic turbine is provided by an engine-driven pump or by an engine-driven pump combined with a high-pressure hydraulic fluid accumulator charged by the engine driven pump. During typical “stop and go” driving situations, the accumulator is charged by the engine-driven pump using energy of decelerating vehicle whenever possible, thus improving the fuel economy of the vehicle. In a preferred embodiment, when the hydraulic turbine is not needed because sufficient air is provided by turbocharger alone, a hydraulic bypass valve is opened by a controller unloading the hydraulic pump in sequence with opening the clutch and disconnecting the pump from the engine drive. When the hydraulic turbine is needed to drive the compressor, the controller connects the clutch first and then sequentially starts closing the bypass valve to produce required amount of boost to the engine. Each of several preferred embodiments utilize a plastic-metal turbine wheel (similar to the turbine wheel described in Applicant's '286 patent in which the plastic portion of the wheel other than the blades is solidly anchored within a metal containing wheel. The superchargers provided by the present invention produce immediate response to engine demand for increased combustion air and re-circulated combustion gases and will dramatically reduce emission of particulate matter and nitrous oxides during steady state driving and especially during low speed acceleration of bus and truck diesel engines.

### BRIEF DESCRIPTION OF THE DRAWINGS

FIG. 1 is a cross sectional drawing showing a preferred embodiment of a high-speed radial inflow hydraulic turbine driven single-stage axial flow compressor coupled to a standard turbocharger compressor inlet with a high-efficiency air duct.

FIG. 2 is a cross sectional drawing showing a preferred embodiment of a high-speed radial inflow hydraulic turbine driven two-stage axial flow compressor coupled to a standard turbocharger compressor inlet by a high-efficiency air duct.

FIGS. 3 and 3A are layouts of the hydraulic system utilizing an engine-driven hydraulic pump to drive the supercharger portion of the high-pressure air system.

FIG. 4 is a layout of the hydraulic system utilizing engine driven hydraulic pump in combination with high pressure hydraulic accumulator driving the supercharger portion of the high-pressure air system.

FIG. 5 is a performance map of a standard commercially available turbocharger compressor showing the pressure ratio and air flow rate increase with the single-stage and two-stage supercharger-turbocharger high-pressure air systems. FIG. 6 is the same a FIG. 12 from Applicant's '286 patent.

### DETAILED DESCRIPTION OF THE PREFERRED EMBODIMENTS

Most engine manufacturers are now in need of high pressure ratio turbocharger systems exceeding a 4.0 level ratio while handling the high EGR rates, high air/fuel ratios and fast turbocharger response to acceleration demand, all at the same time. The present invention provides a practical and economically achievable solution. Applicant has analyzed a typical future heavy-duty 12-liter truck engine meeting the emission standards and at the same time providing reasonable power level and acceleration. Applicant's analysis shows that the required boost pressure ratio to be in the 4.3 to 4.6 range. Summary of required power levels and various parameters for the typical 12-liter engine is shown below:

| | | |
|---|---|---|
| Engine Speed (rpm) | 2200 | 1200 |
| Engine Power (kW) | 375.0 | 240.0 |
| Air + EGR Gas Flow (lb/min) | 112.4 | 53.5 |
| EGR % | 30.0 | 30.0 |
| A/F | 4.6 | 24.6 |
| PRc tot. | 4.26 | 3.71 |
| PRcturbo | 3.15 | 2.65 |
| PR super/asssit | 1.35 | 1.40 |
| N super/assist (kW) | 32.6 | 17.6 |
| Nturbocharg. (kW) | 169.8 | 68.7 |
| Dlt P engine (psi) | 0.46 | 0.41 |

“Air + EGR Gas Flow” equals total mass flow rate into the engine.
“A/F” is ratio of mass flows of air and fuel.
“PRc tot” is product of supercharger pressure ratio times turbocharger pressure ratio.
“PRcturbo” is the turbocharger compressor pressure ratio.
“PR super/assist” is the pressure ratio of axial supercharger.
“N super/assist” is shaft power required by axial flow supercharger that is provided by the hydraulic turbine.
“Nturbocharg” is the turbocharger shaft power.
“Dlt P engine” is difference between engine intake and engine exhaust pressures.

The above data shows that the hydraulic turbine needs to be able to produce up to 32.6 kW (43.8 HP) of power to drive the high-efficiency axial flow compressor. Optimum speed for a supercharger using axial flow compressor is approximately 55,000 RPM. Applicants very high-speed hydraulic turbine wheel weighing 18 grams with a 30 mm wheel diameter can easily provide 32.6 kW at 55,000 RPM at very high efficiency. Similar hydraulic turbines with 25 mm diameter wheel shown in Applicant's '286, has been tested at 26 HP with more than 80 percent hydraulic efficiency. The efficiency of the axial flow compressor incorporating a special aerodynamic duct arrangement is estimated to be between 84 to 86 percent. This design provides a substantial improvement over the overall compression efficiency of the two stage centrifugal flow arrangement shown in Pat. No. 6,062,028. Applicant's axial flow compressor is driven independent of the engine output and provides almost instant boost on demand. By comparison, the two stage centrifugal flow turbocharger driven by single exhaust turbine responds only to increased engine output. Thus, it is slow in responding to acceleration demand in addition to its relatively high rotating inertia which requires additional power to accelerate. Two turbochargers in series driven by exhaust gasses respond only to increased engine speed and load. Applicant believes, therefore, that it is unlikely that the two turbochargers in series will be able to provide sufficient transient acceleration and meet engine emission limits required by modem heavy duty diesel engines. Also two turbochargers in series have substantially lower overall compressor efficiency than a hydraulic turbine driven axial flow supercharger in series with standard turbocharger.

### FIRST PREFERRED EMBODIMENT

### Single Stage Axial Flow Compressor

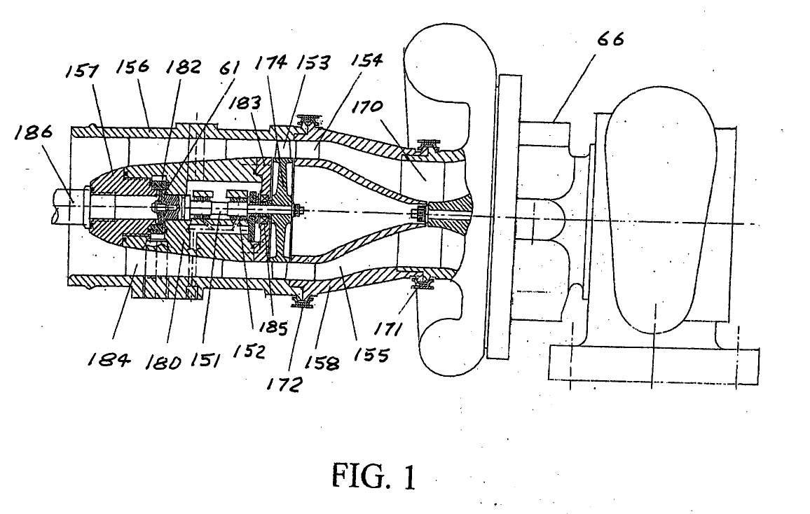

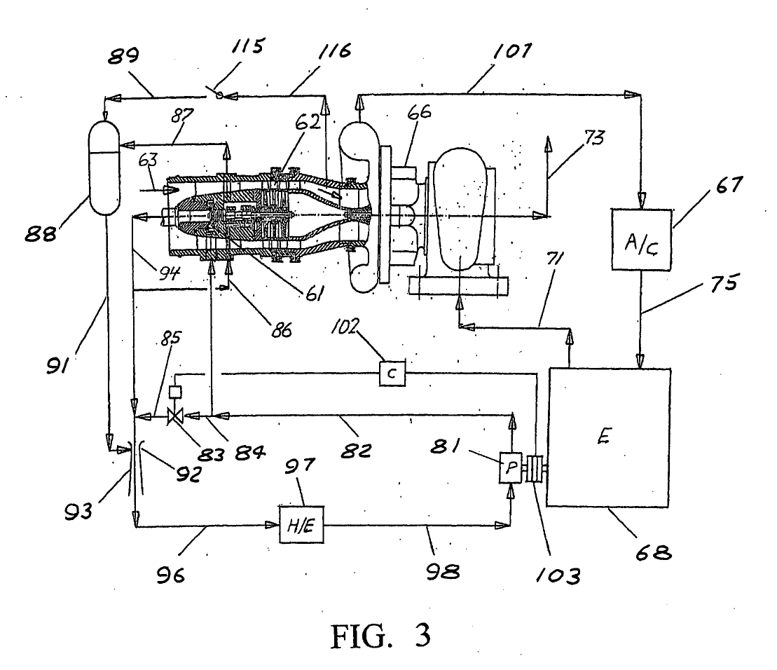

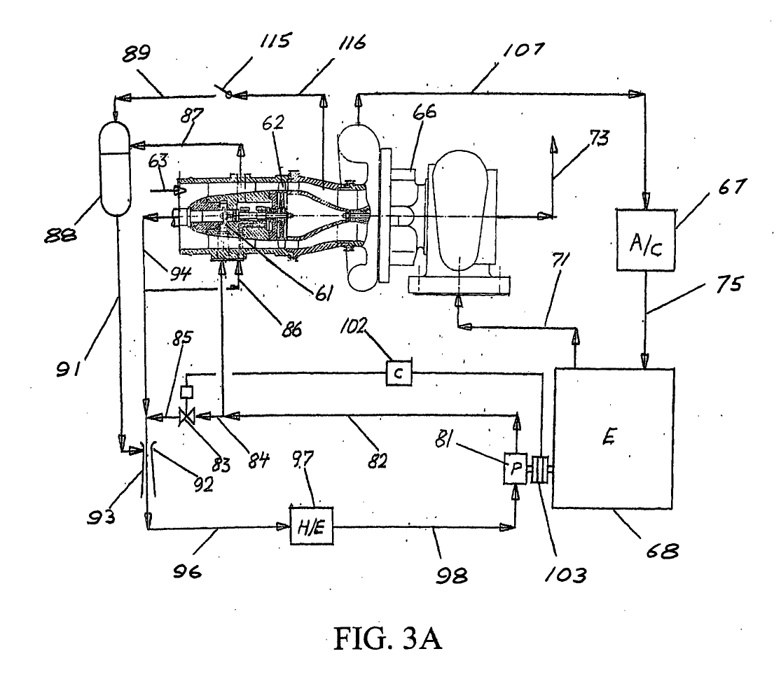

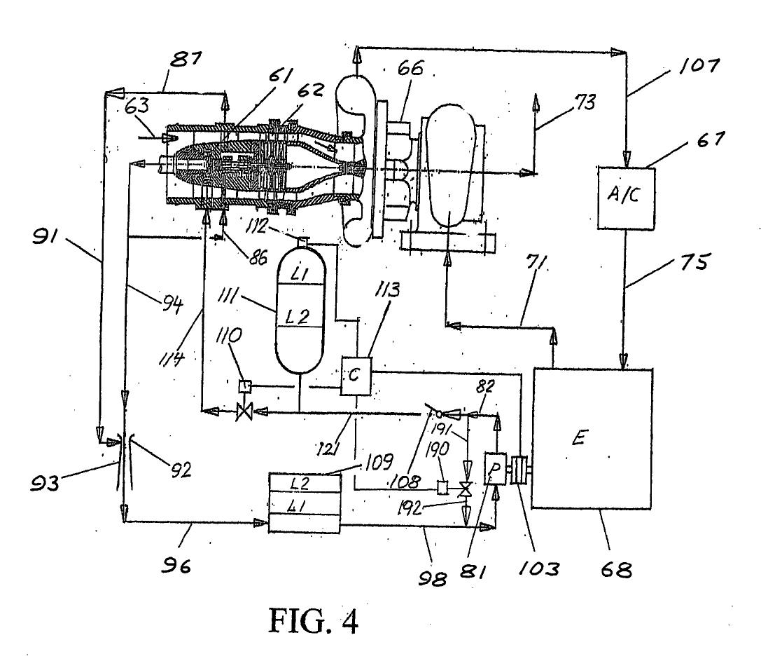

FIG. 1 is a cross sectional drawing showing a preferred embodiment of a high-speed radial inflow hydraulic turbine driven single-stage axial flow compressor coupled to the compressor inlet of a standard turbocharger 66 (Turbonetics Model Number N K76) with a high-efficiency air duct 158. FIG. 1 shows axial flow compressor blades 153 solidly attached to compressor wheel 174 which is solidly attached to shaft 151. Hydraulic turbine wheel 61 driving compressor wheel 174 is solidly attached to shaft 151. Axial flow compressor blades 153 are aerodynamically designed and this design has been checked in two-dimensional cascade tests of NACA 65 Series compressor blades as reported in NACA Report No. 1368. Optimized compressor design using such NACA 65 Series blades data has produced aerodynamic efficiencies in excess of 80 percent in subsonic compressors that have been designed and built by Applicant. Stator blades 154 are designed aerodynamically to achieve optimum utilization of vortex leaving the compressor blades 153, thus providing a uniform straight axial flow downstream of stator blades 154. In order to maximize the total energy transfer from stator blades 154 into the compressor inlet 170 of the turbocharger 66, the cross sectional flow area of passage 155 is maintained approximately constant or is slightly decreasing thus transferring nearly all the kinetic energy of flow leaving the stator blades 154 into compressor inlet 170 of turbocharger 66 with a minimum pressure loss. Such energy transfer arrangement results in a total axial flow compressor efficiency of 86 to 89.5 percent. Test data used to optimize such high axial flow compressor efficiency was published by Prof. B. Eckert and E. Schnell, Axial Compressoren und Radial Compressoren, Berlin, Springer Verlag, 1953. Axial flow compressor housing 156 is solidly connected to transition duct 158 by a V-band 172. Transition duct 158 is solidly connected to turbocharger 66 by a standard V-band connector 171. Bearing housing 180 is cast integrally with axial flow compressor housing 156 to which it is connected with aerodynamically shaped vanes 184 containing hydraulic fluid passages described further in FIGS. 3 and 4. Bearing housing 180 contains bearings 152 and turbine nozzle ring 182. Bearing cover 183 contains shaft seal 185 and is pressed against bearing housing 180 with screws (not shown). Turbine cover 157 is screwed into bearing housing 180 sealing tightly turbine nozzle ring 182. Hydraulic turbine discharge fitting 186 is screwed tightly into turbine cover 157 and is described further in FIGS. 3 and 4.

### Hydraulic Turbine Drive and Control System

FIG. 3A shows the hydraulic turbine drive and control system driving a single-stage axial flow supercharger. This arrangement is similar to FIG. 12 in Applicant's '286 patent except it includes check valve 115. In this preferred embodiment engine 68 is a 12 liter heavy-duty diesel engine driving hydraulic pump 81 which is pressurizing line 82 which channels the high-pressure hydraulic fluid into hydraulic turbine 61 and bypass valve 83 via line 84. Hydraulic turbine 61 provides driving power to axial compressor 62. Hydraulic pump 81 is standard commercially available hydraulic pump Parker Model K73. Bypass valve 83 when open allows hydraulic fluid to bypass turbine 61 and unloads hydraulic pump 81. To prevent unnecessary wear and friction losses of pump 81, when the high pressure hydraulic fluid is not needed, it is desirable to disconnect pump 81 from engine 68. This is accomplished with clutch 103. Such clutch is commonly used in driving hydraulic pumps and is commercially available from suppliers such as Northern Hydraulics with offices in Burnsville Minn. In order to increase useful life of clutch 103, it is desirable to connect and disconnect the pump under minimum pump load whenever possible. For this reason, controller 102 preferably cause bypass valve 83 to open a fraction of a second before clutch 103 disengages pump 81. Also, controller 102 causes bypass valve 83 to close a fraction of a second after clutch 103 engages. These precautions minimize wear on clutch 103.

Also, there are other important functions which are provided by sequential activation and deactivation of bypass valve 83 and pump 81 via clutch 103. When pump 81 is disengaged, virtually no oil flows through any oil lines. However, it is important that forced lubrication through line 86 be established prior high speed rotation of turbine 61. Previously described sequential closing of bypass valve 83 allows for free oil flow to bypass turbine 61 and establish full lubrication via line 86 prior to high speed rotation of turbine 61 caused by closing bypass valve 83. During disengagement of pump 81, the sequence is reversed in that bypass valve 83 opens first which allows turbine 61 to slow down prior to disengagement of pump 81 via clutch 103 which in turn causes the stopping of forced lubrication via line 86.

Turbine discharge line 94 is connected to bypass valve discharge line 85. The amount of discharge oil flow from turbine wheel 61 is reduced by bearing lubricant flow of approximately 1 GPM which flows through line 86. The combined flow from the bypass valve 83 discharge and turbine wheel net discharge flow are forced to flow through throat 92 of venturi nozzle 93. The diameter of throat 92 is sized to provide drop of static pressure at the throat 92 location of about 50 psi. This location serves as the return point for the lubricant flow supplied to supercharger bearings via line 86. The bearing drain line 87 is connected to a small expansion tank 88 which provides for thermal expansion of the hydraulic fluid and as degassing point for the hydraulic fluid. Expansion tank 88 is further connected via line 91 to the throat 92 of venturi 93. Bearing lubricant flow from line 91 joins at that point the combined turbine discharge and bypass valve discharge flows, flowing further through the diffuser section of venturi nozzle 93 where about 80 percent of the throat 92 dynamic head of 50 psi is recovered, thus raising the static pressure in line 96 to about 40 psi above throat of venturi 93 static pressure. Hydraulic fluid flows from line 96 into oil cooler 97 where heat losses are rejected. Hydraulic fluid flows further via line 98 back into hydraulic pump 81.

Ambient air which may contain certain percentage of exhaust gas recirculation flow enters the axial flow supercharger air inlet 63 and is pressurized in axial flow supercharger section 62 and flows further into turbocharger compressor 66 where is further pressurized and flows further via air duct 107 into after cooler 67 where large amount of compression heat is rejected. Finally, the cooled compressed air flows into engine 68 via air duct 75. Line 71 is the engine exhaust pipe and line 73 is the turbocharger turbine exhaust pipe.

Expansion tank 88 is connected to the discharge of supercharger 62 via lines 89 check valve 115 and line 116. Pressurized air from supercharger 62 discharge pressurizes expansion tank 88. Check valve 115 prevents air from flowing back from expansion tank 88 into the discharge of supercharger 62 when supercharger 62 discharge pressure falls below the pressure in the expansion tank 88. Pressurization of the expansion tank 88 raises oil pressure at the inlet of the pump 81 which improves volumetric performance of pump 81. Check valve 115 prevents depressurization of the expansion tank 88 which prevent oil degassing and potential foaming when pressure in the discharge of supercharger 62 decreases. This basic system has been extensively tested and proven by the Applicant.

### SECOND PREFERRED EMBODIMENT

### Two Stage Axial Flow Compressor

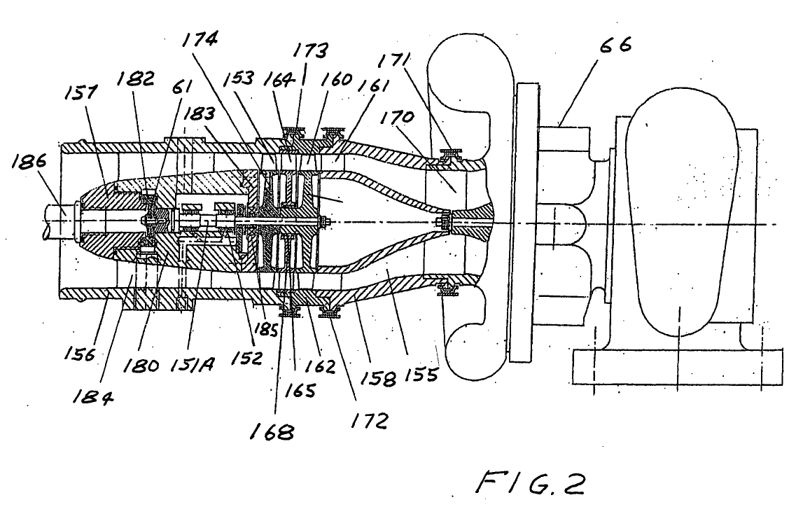

FIG. 2 is a cross sectional drawing showing a second preferred embodiment of a high-speed radial inflow hydraulic turbine driven two-stage axial flow compressor coupled to a standard turbocharger compressor inlet by a high-efficiency air duct. It is very similar to the first preferred embodiment except it comprises two compressor wheels and two sets of compressor blades. Axial compressor blades 153 are solidly attached to compressor wheel 174 and axial compressor blades 160 solidly are attached to compressor wheel 175. Compressor wheel 174 and compressor wheel 175 are solidly attached to extended shaft 151A. Hydraulic turbine wheel 61 solidly is attached to extended shaft 151A and is driving compressor wheel 174 and compressor wheel 175. Axial flow compressor blades 153 and axial flow compressor blades 160 are aerodynamically designed by previously described method.

As in the first preferred embodiment, FIG. 2 shows axial flow compressor housing 156 being solidly connected to second stage housing 162 by a V-band 173. Second stage housing 162 is solidly connected to transition duct 158 by a V-band 172. Transition duct 158 is solidly connected to turbocharger 66 by a V-band 171. As before, transition duct 158 is aerodynamically designed by previously described method. Inter stage diaphragm 168 attached to stator blades 164 and second stage housing 162 incorporates labyrinth shaft seal 165 which minimizes air leakage between cavities connecting axial flow compressor blades 160 and axial flow compressor blades 164. Arrangement of bearings and hydraulic turbine is identical to previously described single stage axial flow compressor.

FIG. 3B shows a preferred hydraulic turbine drive and control system driving a two-stage axial flow supercharger. This is basically the same as the turbine drive and control system described above for the single stage supercharger system except in this case a two stage axial flow supercharger is utilized.

### Design Details—Single Stage and Two Stage Models

The hydraulic turbine driven axial flow superchargers described herein will provide very substantial advantage in cost and performance, especially for heavy duty diesel engines required to meet new emission limits for nitrous oxide and particulate matter. These engines need very high manifold pressures in the range of 4.5 to 5.5 bars. (A manifold pressure of 5 bar corresponds to a pressure ratio of 5.) The following design details are applicable to two preferred embodiments described above:

| | Axial flow - | Axial flow - |
|---|---|---|
| Supercharger Model | Single stage | Two stage |
| Turbocharger | Turbonetics | Turbonetics Model |
| | Model T76 | T76 |
| Engine Power (kW) | 375 | 448 |
| Manifold Pressure (bar) | 4.5 | 5.1 |
| Total Air Flow (lb/min) | 98.4 | 117.1 |
| % EGR | 20 | 20 |
| Turbocharger Press. Ratio | 3.19 | 3.34 |
| Turbocharger Compressor Eff. | 0.74 | 0.73 |
| Turbocharger Power (kW) | 151 | 196 |
| Ax.Flow Superch.Press.Ratio | 1.41 | 1.53 |
| Ax.Flow Superch. Efficiency | 0.86 | 0.86 |
| Ax.Flow Superch. Power (kW) | 30.0 | 45.0 |
| Ax.Flow Compressor Dia. (mm) | 102.0 | 102.0 |
| Supercharger speed (RPM) | 56,000 | 52,000 |
| Hydraulic Turbine pressure (psi) | 2800 | 3000 |
| Hydraulic Turbine flow (gpm) | 30.6 | 42.0 |
| Hydraulic Turbine Efficiency | 0.80 | 0.80 |
| Hydr.Turbine Wheel Dia. (mm) | 33.5 | 34.6 |

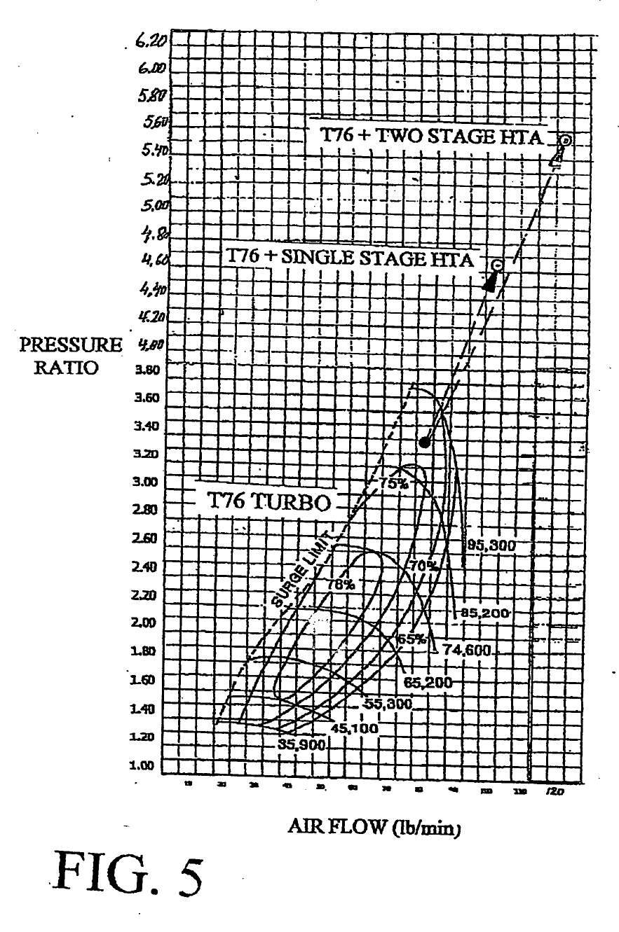

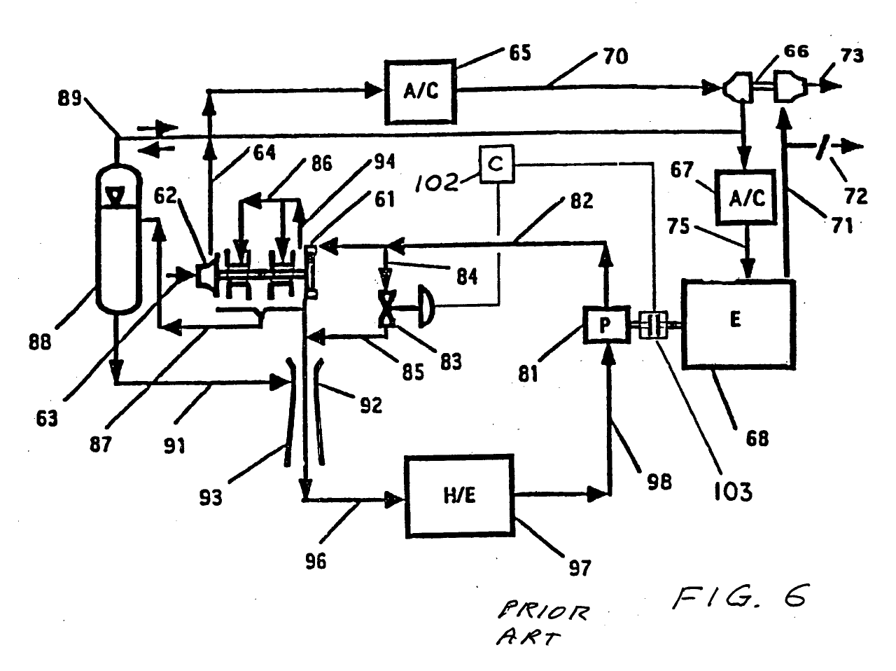

FIG. 5 shows compressor map of the Turbonetics T76 turbocharger with the improvements in compressor pressure ratio and air flow rate when using the hydraulic turbine driven single stage and hydraulic turbine driven two stage axial flow supercharger in series with T76 turbocharger. The points indicated in FIG. 5 as Single Stage HTA and Two Stage HTA show how far the existing compressor map can be extended with the hydraulic turbine driven axial flow superchargers. The speed and power is controlled independently from engine speed by appropriately adjusting the hydraulic turbine inlet pressure. Thus, increase in engine boost can be provided ahead of actual engine and vehicle acceleration which will greatly improve engine torque and reduce emissions during “stop and go” driving. Hydraulic turbine driven axial flow superchargers can be combined with variety of commercially available turbochargers and different engines in sizes from 1 liter to 15 liter displacement. These embodiments use the basic elements of Applicant's well-proven prior art hydraulic turbine drives. But Applicant's prior art hydraulic turbine technology is combined with other known technology to solve a major problem of engine manufacturers in the United States and in other countries. These designs are useful in a broad range of engines requiring assist supercharger power ranging from 7 kW at 160,000 RPM to 60 kW at 45,000 RPM.

### Hydraulic Turbine Drive Accumulator System

FIG. 4 shows details of a hydraulic turbine drive system utilizing a high-pressure hydraulic accumulator. This arrangement is similar to FIG. 3 system, except that hydraulic turbine 61 can be driven by hydraulic pump 81 or by high-pressure accumulator 111 or by hydraulic pump 81 in combination with the high-pressure accumulator 111. High pressure accumulators are commercially available as nitrogen pre-charged bladder accumulators from well-known catalogs such as Grainger, McMaster-Carr and Lincoln Composites, Inc.

The main advantage of this system is that accumulator 111 can be charged during vehicle deceleration using vehicle kinetic energy or be charged during engine part load. It can be discharged to drive the hydraulic turbine 61 and produce high pressure ratio supercharging at the point requiring maximum engine power, while minimizing the power required to drive the hydraulic pump. In addition to higher performance and lower emissions it also provides fuel savings.

Hydraulic pump 81 charges the high-pressure accumulator 111. High-pressure hydraulic oil flow generated by the hydraulic pump 81 flows through line 82, check valve 108 and line 121 charging the high-pressure accumulator 111 from a low pressure of approximately 1500 psi to a high pressure of approximately 3500 psi. High-pressure accumulator is preferably of the bladder type that is pre-pressurized with 1500 psi nitrogen gas. Check valve 108 prevents hydraulic fluid to flow from high pressure accumulator into lines 82 and 191 thus preventing reverse flow through a de-coupled hydraulic pump 81 and through bypass valve 190. When hydraulic turbine 61 is required to produce power the turbine control valve 110 starts to open which allows for high pressure hydraulic fluid to flow into hydraulic turbine 61 via line 114. Controller 113 controls turbine 61 power output via control valve 110. It also controls pump bypass valve 190 and clutch 103. When high pressure accumulator 111 reaches its maximum pressure a signal form pressure transducer 112 to controller 113 causes first the bypass valve 190 to open and unload the hydraulic pump 81 and a small fraction of a second later the clutch 103 disconnect the pump from the engine drive. This sequence is reversed during the pump engagement. As previously explained in the FIG. 3 system description, such bypass valve-clutch sequencing minimizes clutch wear.

When hydraulic turbine 61 is required to produce power over extended periods of time causing the hydraulic accumulator 111 pressure to fall below pressure required by hydraulic turbine 61, hydraulic pump 81 is engaged providing required fluid flow to the hydraulic turbine 61 and high pressure accumulator 111. As previously described the engaging and disengaging of hydraulic pump 81 is done in sequence with bypass valve 190. When the need for hydraulic turbine 61 power is reduced the hydraulic pump 81 continues to supply high pressure hydraulic fluid to hydraulic turbine 61 and high-pressure accumulator 111. In this case the fluid flow charging accumulator equals the excess flow produced by hydraulic pump 81 above the flow needed to power the hydraulic turbine 61. When pressure in high pressure accumulator 111 reaches its maximum the hydraulic pump is de-clutched. When hydraulic turbine 61 is required to produce power the high pressure accumulator 111 provides pressurized fluid flow and as fluid pressure falls below that required by the hydraulic turbine 61 the hydraulic pump 81 is again engaged as described earlier.

Hydraulic turbine 61 discharges hydraulic fluid flow through line 94 causing pressure drop through venturi nozzle 93 and causing pressurized lubrication to supercharger bearings via lines 86, 87 and 91 as described earlier. The combined turbine and bearing hydraulic flow is channeled into drain tank 109 which is sized to match volume of hydraulic fluid discharged from high pressure accumulator 111. Fluid levels L1 and L2 indicated in drain tank 109 and high-pressure accumulator 111 correspond to each other. Expansion tank 88 shown in FIG. 3 was eliminated in this embodiment because the drain tank 109 serves same function in system shown in FIG. 4.

### Independent Control of Supercharger System

A very important advantage of the present invention over the prior art two-stage single shaft turbochargers is that the present system can be controlled relatively independently of the engine speed and load. This is simply done by adjusting the bypass flow through the valve 83. This permits much higher power and lower emissions at low speeds. Use of high pressure accumulator 111 permits almost instant boost response when required by the engine. This characteristic combined with ability to charge high pressure accumulator by using vehicle kinetic energy during the vehicle deceleration makes this novel system ideal for stop and go heavy duty engine applications.

While the above examples describe preferred embodiments, persons skilled in this art will recognize that many changes and additions can be made without departing from the basic scope of the invention. For example, addition of a third axial flow stage to the axial flow compressor is a possibility. Also, a flexible duct or similar connector may be substituted for the rigid V-band clamp connecting the axial flow supercharger to the to the turbocharger compressor inlet. Therefore, the scope of the invention should be determined by the appended claims and their legal equivalence and not by the specific examples given above.

I claim:

1. A high efficiency supercharger system for supplying a very high pressure ratio compressed gasses to an internal combustion engine, said system comprising:
A) a turbocharger driven by exhaust gasses from said engine, said turbocharger comprising a blower unit for supplying high-pressure gasses to said engine;
B) a high-speed hydraulic driven supercharger supplying intake gasses to said turbocharger, said supercharger comprising:
1) a shaft;
2) a high speed radial inflow hydraulic turbine drive comprising a turbine wheel mounted on said shaft;
3) an axial flow compressor comprising a compressor wheel mounted on said shaft;
C) a hydraulic fluid pump, defining a hydraulic fluid pump intake, driven by said engine for providing high-pressure hydraulic fluid for driving said supercharger;
D) a foam prevention means for maintaining sufficient pressure at the fluid pump intake to avoid any significant foaming at said hydraulic fluid pump intake.

2. The system as in claim 1 and further comprising an expansion tank pressurized by gas discharged from said supercharger via pressure piping connecting said expansion tank with said supercharger discharge.

3. The system as in claim 2 wherein said foam prevention means comprises a check valve in said pressure piping.

4. The system as in claim 1 and further comprising an accumulator pressurized by said hydraulic fluid pump and a control valve for controlling fluid flow from said accumulator to said hydraulic turbine drive.

5. The system as in claim 4 wherein said accumulator is a bladder type accumulator.

6. The system as in claim 4 wherein said foam prevention means includes said accumulator.

7. The system as in claim 1 wherein said supercharger is a single-stage supercharger.

8. The system as in claim 1 wherein said supercharger is a two-stage supercharger.

9. The system as in claim 1 wherein said supercharger is a multi-stage supercharger.

10. The system as in claim 1 and further comprising a bypass valve to permit hydraulic fluid from said pump to bypass said supercharger when the supercharger is not needed.

11. The system as in claim 10 and further comprising a clutch for disengaging said hydraulic pump.

12. The system as in claim 1 wherein said supercharger comprises a plastic-metal turbine wheel in which the plastic portion of the wheel other than turbine blades is solidly anchored within a metal containing wheel.

13. The system as in claim 1 wherein said system provides a pressure ration of at least 4.75.
